(19) United States
(12) Patent Application Publication
(10) Pub. No.: US 2016/0196349 A1
(43) Pub. Date: Jul. 7, 2016

(54) GEOCODING MULTI-ENTITY QUERIES

(71) Applicant: MICROSOFT TECHNOLOGY LICENSING, LLC, Redmond, WA (US)

(72) Inventors: Pavel Berkhin, Sunnyvale, CA (US); Michael Evans, Sunnyvale, CA (US); Florin Teodorescu, Redmond, WA (US)

(21) Appl. No.: 14/591,856

(22) Filed: Jan. 7, 2015

(51) Int. Cl. G06F 17/30; G06K 9/20

(52) U.S. Cl. CPC G06F 17/30864; G06F 17/30061; G06F 17/3053; G06K 9/2054

(57) ABSTRACT

Aspects of the present invention relate to providing search results on a map view for a multi-entity query. A search query submitted by a user may be received. A tile in a map may be identified based on the search query. Valid query patterns for the search query corresponding to entities on the identified tile may be determined. Potential scores for each of the determined valid query patterns may be calculated. Potential scores for the determined valid query patterns may be ordered. Actual scores for a plurality of the determined valid query patterns may be calculated. Results based on the valid query pattern with the highest actual score are returned

### BACKGROUND

Mapping service applications allow a user to search for an entity (e.g., location) on a map. For example, a user may want to find a particular map location. The user can enter a search query to be determined by a map geocoder, e.g., via a web mapping service application, and the map geocoder can return a most likely location (e.g., the web mapping service application can display the most likely location on a map view). Generally, map geocoders can resolve a single entity per search query.

For more complex queries, e.g., queries containing more than one entity, a mechanism can be provided to perform a multi-entity query search. Examples of multi-entity query search solutions include: (1) pre-indexing (e.g., storing major street intersections as separate entities), and (2) using formal grammar to define a static query pattern for a search query and issuing a separate query for each query segment of the query pattern.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the present invention are directed to resolving a multi-entity query for mapping applications. For example, a user may enter a search query containing more than one entity into a mapping application. Based on the search query, a map tile (e.g., a predefined map area) can be identified. Using the identified map tile, valid query patterns can be determined for the search query. For each valid query pattern, a potential score can be calculated, and the potential scores can be ordered. Then, starting from the query pattern with the highest potential score, an actual score (e.g., the potential score reduced by a geo-spatial collocation factor) for the valid query patterns can be calculated. When an actual score for a valid query pattern is calculated that is greater than the potential scores of the remaining valid query patterns, results can be returned based on the valid query pattern with the highest actual score.

### BRIEF DESCRIPTION OF THE DRAWINGS

Aspects of the invention are described in detail below with reference to the attached drawing figures, wherein:

FIG. 1 is a block diagram of an exemplary computing environment suitable for implementing aspects of the invention;

FIG. 2 is a diagram of an query environment suitable for resolving multi-entity geocoding queries, in accordance with an aspect of the present invention;

FIG. 3 is a flowchart showing a method of resolving multi-entity geocoding queries, in accordance with an aspect of the present invention;

FIG. 4 is a flowchart showing a method of resolving multi-entity geocoding queries, in accordance with another aspect of the present invention;

FIG. 5 is a flowchart showing a method of resolving multi-entity geocoding queries, in accordance with yet another aspect of the present invention;

FIG. 6 is an example of a map depicting the results of a multi-entity geocoding query comprising intersecting streets and a business name, in accordance with an aspect of the present invention; and

FIG. 7 is an example of a map depicting the results of a multi-entity geocoding query comprising two non-intersecting streets, in accordance with an aspect of the present invention.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Providing search results in response to queries that contain search terms related to two or more entities can pose a variety of challenges. As noted below, an entity as used herein can refer to any type of feature or object that can be suitable for display in a map view. Some difficulties can relate to determining what types of results are responsive to the query. For example, if the query is processed according to conventional search methods, the highest ranking responsive results for the query (such as documents matching the search terms) may end up being primarily or even exclusively related to only one of the entities included in the search terms. This problem can be magnified in situations where it is desirable to provide a map view as part of the results in response to a query. According to conventional search methods, the map view presented as part of the results may focus on only one of the entities to the exclusion of the other entities included in the search terms.

One alternative can be to segment the query in order to identify the presence of multiple entities within the search terms of the query. However, without knowing where to segment the search query in order to identify the multiple entities, processing the possible combinations of segments in an effort to identify multiple entities can be prohibitive from a computational expense standpoint. This problem can be magnified for search queries related to the type of large document corpus that is often available on a wide area network.

Different strategies have been used to decrease the time spent and computing resources expended for multi-entity queries on a map. For example, predetermined rules can be used to partition a query into multiple sub-queries, where an operation is run for each sub-query, and a map geocoder returns a single entity for each sub-query. However, this can be computationally expensive, since an operation must be run for each sub-query. As another example, rules, such as lookup tables, covering popular multi-entity queries may also be used. For example, a system may look for a pattern [business][adjective][city],” keeping an index of known business names and major cities. However, a query that does not match this pattern would default to a single-entity query or require an alternate search strategy.

For queries containing two or more entities that are also related to a location, such as queries where a map view is a desired result, searching spatial access trees (e.g., KD-tree, R-Tree) can result in slow response times. Queries with ambiguous locations requiring a spatial search for more than one entity are expensive, and are traditionally either not processed using a spatial search or are searched using a strategy appropriate for a query directed to a single entity. Pre-materializing popular multi-entity queries (e.g., major street intersections in large cities) requires that the multi-entity queries be added to an index as additional entries, and only those multi-entity queries that are added are properly resolved. All of the aforementioned approaches also run into issues when the results responsive to the search query do not correspond to a specific location (e.g., non-intersecting streets) or have multiple potential locations (e.g., “pizza shop near a barber”).

Aspects of the present invention relate to resolving multi-entity geocoding queries. According to an aspect of the present invention, a tile of a map can be identified using conventional searching strategies. For example, an inverted index may be used to determine whether search terms of the search query correspond to entities found for a particular map tile. This allows the search space to be limited to a single tile (or a limited number of tiles), greatly reducing the possible number of entity combinations to be examined.

Once a tile is identified, potential query patterns may be determined for the search query based on the identified tile. An initial calculation can be performed for each query pattern based on a first set of ranking factors to obtain a potential score. In some aspects, the first set of ranking factors can be a limited set of factors, such as a static rank (i.e., one or more factors that have static values based on an identified entity), textual factor (i.e., factors related to the text of the query), location factor (i.e., factors related to the location), or a combination thereof. In such aspects, calculating potential scores can be faster and consumes less computing resources than calculating actual scores. For example, the potential scores for the query patterns can be calculated without considering factors requiring more intensive calculations, such as factors related to geographic distances between entities.

In some aspects, the potential score for a query pattern may have a predetermined relationship with the actual score for the query pattern after additional ranking factors are considered. For example, the factors for the actual score can be selected to include all of the factors for the potential score plus one or more additional factors, such as geographic- or distance-based factors. The one or more additional factors can all correspond to factors that result in the same type of modification of a query score. As an example, a distance-based factor can be defined to have a greater negative impact on the actual score as the distance related to the factor increases. The distance-based factor can correspond to a distance between multiple entities corresponding to a query pattern in the search query, a distance between an entity and a location associated with the user that submitted the search query, or any other type of distance-based factor. Based on this type of definition, adding the distance-based factor to the calculation for the potential score results in an actual score that is less than or equal to the potential score. Using similar types of definitions for the one or more additional factors, it can be known in advance or predetermined that the potential score for a query pattern will be greater than or equal to the actual score after inclusion of the one or more additional factors.

The query patterns can be organized or ordered based on the potential score associated with each query pattern. Then, actual scores for the query patterns can be calculated. In some embodiments, the order in which actual scores for the query patterns are calculated can be based on the predetermined relationship between potential scores and actual scores for the query patterns. For example, if a potential score for query patterns is known to be greater than or equal to the actual score, the actual scores can be calculated in some order so that the actual scores for query patterns with higher potential scores are calculated first. With this type of strategy, once an actual score is calculated for a query pattern that is greater than the potential score for all remaining query patterns without a calculated actual score, this query pattern can be identified as having the highest actual score. This can provide substantial savings in determining rankings for query patterns. As another example, the query patterns can be grouped by potential scores (e.g., using a bucket sort) and the actual scores can be calculated for a group, where the query patterns in the group with the highest values are calculated first. As yet another example, a highest potential score can be determined and actual score may be calculated for query patterns with potential scores within a certain range of the highest potential score. It should be understood that although the above examples illustrate various ways of determining query patterns for calculating actual scores, other methods of determining query patterns for calculating actual scores can be used as well.

Since calculating an actual score may be computationally expensive, limiting the number of calculations performed may be desired, e.g., by only perform calculations on patterns where the actual score can be higher that the remaining potential scores (i.e., patterns that have not yet been scored with an actual score). For example, an actual score may be a calculation of the potential score reduced by a factor determined by a geo-spatial collocation of the entities in the query pattern. In this, example, since the actual score cannot be greater than the potential score, query patterns with potential scores less than a highest actual score need not be calculated. However, it may also be desirable to calculate actual scores for query patterns with potential scores within some range of the highest actual score. For example, in order to return multiple results, actual scores may be continued to be calculated for query patterns until the potential scores are below some range of the highest actual score. This would allow for the mapping of multiple results or return results where more than one location may be acceptable to the user.

Results based on the query pattern with the highest actual score can then be returned. The query pattern with the highest actual score is likely the desired result since no other query pattern can return a higher score (since a potential score is a maximum score). This configuration provides the ability to resolve queries to one or more geo-coded entities faster (e.g., in real-time) with no special syntax (“free text search”). Further, this configuration increases user efficiency and reduces network bandwidth usage, since fewer queries can be performed to obtain desired search results. Although returning the result based on the query pattern with the highest actual score is described, this need not be the case. For example, query patterns that have an actual score exceeding a threshold may be returned. Each returned query pattern may be displayed separately on a map view or shown on the same map view.

It is noted that a variety of calculation strategies can be used in connection with the ordered query patterns. One strategy can be to consecutively calculate actual scores for the highest potential score that does not already have a corresponding actual score. As another type of strategy, a sequence of the ordered query patterns could be selected for calculation of actual scores. The actual scores for the query patterns in the sequence could be calculated in an alternative order. For example, the number of entities in the query pattern can be used to determine an order for calculating the actual scores. The end goal could still be to identify an actual score that is greater than any remaining potential score, but the order of calculation of actual scores could vary under this type of aspect. In still other aspects multiple calculations may be performed simultaneously, and a result, can be returned when an actual score exceeds the highest potential score or remaining potential scores. In any of the calculation strategies, resource savings can be realized, since actual scores for all of the query patterns need not be calculated. More generally, a variety of methods for calculating actual scores can be selected while still substantially retaining the benefit of the predetermined relationship between the potential scores and actual scores for reducing calculation costs.

### DEFINITIONS

An entity as used herein can refer to any type of feature or object that can be represented for display in a map view. Some types of entities in a map view can refer to traditional map features, such as streets, buildings, parks, landmarks, or other geographical features. Other types of entities in a map view can correspond to entities that are displayed based on the inclusion of an icon or other symbol. For example, a push pin or other symbol can be used to indicate the location on a map for an entity. An entity represented by an icon or symbol may correspond to a traditional map feature, or an entity may correspond to any other feature that can be associated with a location. Thus, an entity could be a restaurant, a bus stop, the location of a past or future event, or another feature that can be associated with a location in the map view. In some aspects, an entity can correspond to physical entity that is currently present at the corresponding real location represented by the map view, or the entity can correspond to a temporal entity that is associated with a location at a time in the past or future. The term “multi-entity geocoding query” as used herein refers to a query that contains two or more entities for the given query. For example, the multi-entity geocoding query “Baker St and Main St” may be split up into “Baker St” and “Main St,” or “Baker” “St” and “Main St” among others.

The term “valid query pattern” as used herein refers to a segmentation of a multi-entity geocoding query where each segment corresponds to at least one entity that can be found on a map tile. For example, the geocoding query “Baker St and Main St” may produce the valid query pattern “[Baker St][Main St].” However, the query pattern “[Baker St][and][Main St]” may be considered invalid since “[and]” may not have a corresponding entity on the map tile. Further, although some terms such as “St” may have corresponding entities on a map tile, a pattern such as “[Baker][St][Main St]” may be found invalid since “[St]” does not provide enough descriptiveness or has little value (i.e., “St” can refer to any street on the map tile).

The term “tile” or “map tile” refers to a predefined area of a map view with a predetermined shape and size. For example, a tile may be a 2 km×2 km square centered at a specific location or at specific coordinates. In some examples, tiles do not overlap on a map view. For example, the tiles may form a grid pattern that covers the area of the map view. A tile is not constrained to a specific size and/or shape and may be any pre-determinable size and shape. Furthermore, tiles need not be uniform in size and/or shape and each tile can have a different size and/or shape.

As used herein, “real time” refers to a situation where a user perceives an operation being performed immediately or within a very short period (e.g., <50 ms). It should be noted that a real time operation is from the perception of the user and not of the computing device or system.

### Multi-Entity Query

A user may want to search for multiple entities on a map or a single location using two or more entities. For example, a user may want to find a location based on more than one search term. Thus, the user may submit a search query with more than one search term for execution of a search by a mapping service application. A mapping service application is an application that can take a search term and return a map view centered on an entity corresponding to the search term.

A tile in a map view can be identified based on the search query. For example, a tile can be identified using conventional search capabilities, e.g., using an inverted index, to obtain a most likely tile (i.e., the tile with the highest rank or score). The highest ranked result would be identified as the desired tile.

Next, valid query patterns for the search query can be determined. For a query that includes multiple entities, a query pattern may be considered valid when each of search terms of the query correspond to entities can be found on the identified map tile. For example, the search query may be divided into search terms, and each search term may be analyzed to determine if it resolves to at least one entity on the identified tile (i.e., the search term corresponds to an entity on the identified tile). If each of the search terms resolves to at least one entity on the identified tile, then it can be determined whether the entities reside on the same sub-tile. A query pattern may be considered valid when the search terms of the search query correspond to entities on the identified tile, and the entities are found on the same sub-tile.

Next, potential scores for each of the valid query patterns can be calculated. For example, the potential score for each valid query pattern can be calculated based on a static rank, textual factor, and location factor for each entity of the determined valid query pattern.

Next, potential scores for the valid query patterns can be ordered by value. This allows query patterns with higher potential scores to be examined earlier than query patterns with lower potential scores. However, the query patterns need not necessarily be ordered. For example, if a highest potential score can be determined, the actual scores can be calculated in any order. Once an actual score exceeds the highest potential score of the remaining query patterns, further calculations may not be needed.

Next, actual scores for the valid query patterns can be calculated. For example, the actual score for a valid query pattern may be the potential score of the pattern reduced by a distance-based factor (e.g., geo-spatial collocation factor). The distance-based factor can correlate to the Cartesian distance between the entities of the valid query pattern. As an example, the distance-based factor can be defined to have increasingly negative values as the Cartesian distance related to the factor increases. Since calculating actual scores (e.g., calculating Cartesian distances between entities) is computationally expensive compared to calculating potential scores, by only calculating actual scores for query patterns with high potential scores, the number of computationally expensive calculations can be decreased. Specifically, only the valid query patterns whose potential score is greater than a highest calculated actual score need to be examined. For query patterns whose potential score is less than the highest actual score, an actual score need not be calculated since the actual score cannot exceed the potential score (since the actual score is the potential score penalized by a geo-spatial collocation factor).

Next, results based on the valid query pattern corresponding to the highest actual score are returned. For example, the results may be returned as an image, an overlay on a map view, or any other format indicating the entities on the grid. In other embodiments, the results may be returned in a format in order for, e.g., a mapping service application to display the returned results.

### Query Patterns

In an example embodiment, a search query can be represented by the equation:

\vec{q}=(g₁q₂ . . . qₙ)

where \vec{q} represents the search query and q₁q₂ . . . qₙ represents each term in the search query. The query \vec{q}=(q₁q₂ . . . qₙ) can be matched to a set of entities. For example, if a query has four terms, the query can be matched to one entity

$$\frac{{e}_{1}}{[ {q}_{1} {q}_{2} {q}_{3} {q}_{4} ]} ,$$

to two entities

$$\frac{{e}_{1}}{[ {q}_{1} {q}_{2} ]} \frac{{e}_{2}}{[ {q}_{3} {q}_{4} ]}$$

located nearby each other, or to other entities. For example, a query “Geary Blvd and Franklin St” matches a set of two entities e₁=“Geary Blvd, San Francisco, Calif.” and e₂=“Franklin St, San Francisco, Calif.” on a tile representing an area of San Francisco, Calif.

A contiguous subset of terms [qᵢqₗ₊₁ . . . qₖ] may be called a query sub-segment or search term and a division of indices 1 . . . n into contiguous sub-segments or search terms may be called a query pattern or pattern. A pattern may be denoted as \vec{p}=(p₁, p₂ . . . pₛ), where each pⱼ=[l . . . k],l=l(j), k=k(j), corresponds to indices of a query sub-segment or search term, which is denoted as q[pⱼ]=[qₗ . . . qₖ]. For example, for a four-term query, a pattern can look like \vec{p}=(p₁p₂), where p₁=[123] and p₂=[4]. Then, q[p₁]=[q₁q₂q₃] and q[p₂]=[q₄]. In any of the embodiments, the terms “sub-segment,” “segment,” and “search term” are used interchangeably. It should be understood that the terms “sub-segment” and “segment” refer to a portion of a search query and do not denote segments of, e.g., different length. It should be understood that the term “search term” refers to a portion of a search query and does not represent the individual words comprising the search query.

A pattern can be fulfilled if each corresponding query segment can be matched by a set \vec{e}=(e₁ . . . eₛ) of collocated entities. This can be denoted as:

$$\frac{{e}_{1}}{q [ {p}_{1} ]} … \frac{{e}_{s}}{q [ {p}_{s} ]}$$

In an example embodiment, patterns may be organized in an ordered data tree structure. The root node contains the one-element pattern \vec{p}=([1 . . . n]). If this pattern is fulfilled, no other search need be required since the query resolves to a single entity query matching all of the query terms. The one-element pattern can be split into n−1 two-element children patterns p=([1 . . . j][j+1 . . . n]), j<n, each consisting of two index sub-segments. These patterns potentially correspond to a two-entity solution. Each of the two-element children patterns can be further split into n−j−1 children by dividing its rightmost sub-segment. In some embodiments, a pattern can have, at most, smax sub-segments.

For a query with n terms and smax=3, the total number of query patterns is equal to 1+(n−1)+(n−1)(n−2)/2. For example, for n=10, there is a total of 46 patterns. This allows for further reduction of computing time and resources since, we may be able to trim nodes containing more than three sub-segments. However, if deeper searching is desire (i.e., more sub-segments), smax can be greater than three.

### Valid Query Patterns

In an example embodiment, a valid query pattern refers to a pattern that can be potentially fulfilled. To be valid, a pattern needs to satisfy two conditions: (1) each query sub-segment has to have entities that match it; and (2) at least one combination of so matched entities has to reside in a common sub-tile.

Let Eⱼ=E (q[pⱼ])={e:q[pⱼ]⊂e} be a set of entities matching q[pⱼ]. Condition 1 is satisfied if and only if Eⱼ≈Ø.

To check condition 2, a spatial bitmask may be used. With every entity e belonging to a tile, a spatial bitmask b(e) can be kept that indicates if the entity location intersects a particular sub-tile of a given tile. For example, for a tile with 256 sub-tiles, each b(e) has 256 bits. A union of all sub-tiles that intersect with at least one entity in Eⱼ has a spatial bitmask

Bⱼ=∪_{eεE}_{ⱼ}b(e).

eEE

If the intersection B(\vec{p})=B₁∩ . . . ∩Bₛ is empty (all bits are 0), a pattern \vec{p} cannot be fulfilled since no combination of entities from E. will be collocated.

Thus, a pattern p is valid if: (1) For all j=1: s a set Eⱼ=E(q[pⱼ])≠Ø; and (2) B(\vec{p})=B₁∩ . . . ∩Bₛ≠Ø

It should be understood that condition 2 is used to reduce the number of patterns and a pattern p may be valid by fulfilling condition 1. For example, if the entities need not reside in the same sub-tile and the pattern fulfills condition 1, the pattern may be used to provide the desired search result.

In sum, to find valid patterns:

```
AdmissiblePatterns (\vec{q}) returns A
Enumerate all subsegments pⱼ of [1 ... n]
Build a tree of all potential patterns \vec{p} = (p₁ ... pₛ) ∈ P
A = Ø
for each subsegment pⱼ do
    Eⱼ = E (q[pⱼ]) = {e: q[pⱼ] ⊂ e}
    Bⱼ = U_{e∈E}ⱼ b(e) // b(e) are computed offline
end for
for each \vec{p} = (p₁ ... pₛ) ∈ P do
    if (∀ j = 1:s Eⱼ ≠ Ø) then
        B(\vec{p}) = B₁ ∩ ... ∩ Bₛ
        if(B(\vec{p}) ≠ Ø) then A = A ∪ {\vec{p}} end if
    end if
end for
return A
```

If Eⱼ=Ø for some j<s, a pattern \vec{p} is invalid, and a whole pattern tree branch under \vec{p} is also invalid, so it may be pruned. Also, if a sub-segment pⱼ has an empty Eⱼ, so does any other sub-segment \vec{p}′ such that \vec{p}⊂\vec{p}′.

When constructing the Eⱼ, The terms in an inverted index can be used. For example, for an inverted index for a term q, along with all entity documents e₁ . . . e_{m(q)}, a bitmask B(q)=b(e₁)∪ . . . ∪b(e_{m(q)}) may be stored. Let B(\vec{q})=B(q₁)∩ . . . ∩n B(qₙ). When constructing lists Eⱼ=E(q[pⱼ])={e:q[pⱼ]⊂e} for sub-segments of the input query \vec{q}, the construction can be limited to e such that b(e)∩B(\vec{q})≠Ø.

By use of query patterns, since the number of all patterns is small and thus, all patterns can be explored, premature convergence (i.e., focusing early on a local optimum) can be avoided. Finding valid patterns also allows for the disqualification of bad branches from being explored.

Potential Score Scoring

In an example embodiment, a potential score may consist of three different components: static rank, textual factor, and location factor.

The static rank may be calculated based on static features: for example, the size of a city containing the entity in terms of population, whether the entity is in a capital of a state, whether the entity has a high popularity, etc. An entity e has a pre-defined static rank hₛₜₐₜ(e).

The textual factor represent how well the entity text matches a query. Term frequency-inverse document frequency (tf-idf), Okapi BM25, true doubles, true triples, etc. are examples of ways to obtain the textual factor. A textual factor hₜₑₓₜ (e| q) can be calculated for the entity e.

The location factor measures the proximity of an entity to a viewport v and/or to user location u. This assigns greater weight to local results. For an entity e, a location factor 0≦h_{dist} (l(e)|v, u)≦1 is defined, where l(e) is the location of the entity.

Overall, a potential score is defined as

h(e|q,v,u)=hₛₜₐₜ(e)hₜₑₓₜ(e|q)/h_{dist}(l(e)|v,u).

For an entity set \vec{e}=(e₁ . . . eₛ) and a segmented query \vec{q}=(q[p₁][p_{S}]), a potential score of an entity set is defined as a product h(\vec{e})=h_{q}(\vec{e})h_{g}(\vec{e}). The first term in the formula combines in itself all non-geometric features:

$${h}_{q} ( {e}^{->} ) = \frac{1}{σ ( s )} {\prod }_{j = 1 : s}^{ } {h}_{stat} ( {e}_{j} ) {h}_{text} ( e \text{\textbar} q ) .$$

The second term measures geometrical features: closeness of a set location l(\vec{e}) to a viewport and user, and the tightness 0≦h_{loc}(\vec{e})≦1 of a set (how closely entities in a set are collocated):

h_{g}(\vec{e})=h_{dist}(l(\vec{e})|v,u)h_{loc}(\vec{e}).

The closest and tightest case corresponds to h_{g}(\vec{e})=1.

Given a pattern set \vec{E}={E₁ . . . E_{S}}:

$${h}_{q} ( {E}^{->} ) = \frac{1}{σ ( s )} {\prod }_{j = 1 : s}^{ } max \{ {h}_{q} ( {e}_{j} ) : {e}_{j} ∈ {E}_{j} \} .$$

### Finding an Entity Set

In an example embodiment, given a valid pattern, finding an entity set is not guaranteed to be fulfilled. For example, finding an entity set fulfilling a pattern where s=smax=3 consists of the following steps:
1. Reduce E₁, E₂, E₃. Note that these sets were defined generically per sub-segment of original query. Given that the entity set lies in sub-tiles with spatial bitmask B(\vec{p})=B₁∩ . . . ∩Bₛ, Eⱼ′={eεEⱼ:b(e)∩B(\vec{p})≠Ø}.
2. Try the top-k scored entities e₁εE₁′. With each such e₁, let E₂^{e}^{₁}={eεE₂′:b(e)∩b(e₁)≠Ø}.
3. If E₂^{e}^{₁}≠Ø, skip e₁. Otherwise, try the top-k scored entities e₂εE₂^{e}^{₁}. Again let E₃^{e}^{₁}^{e}^{₂}={eεE₃′:b(e)∩b(e₁)∩b(e₂)≠Ø}.
4. If E₃^{e}^{₁}^{e}^{₂}=Ø, skip e₁, e₂. Otherwise try the top-k scored entities e₃εE₃^{e}^{₁}^{e}^{₂} and among (e₁, e₂, e₃) determine the set with the best score.

Investigating the top-3 scored entities choices from each segment, only nine entity combinations need to be examined. Thus, when a valid pattern is selected, finding an entity set is not computationally expensive, allowing reduced computing time and resources.

In some embodiments, after obtaining a solution \vec{e}=(e₁ . . . eₛ), the process of examining remaining patterns can be further optimized: if a solution is found, this solution can be used to disqualify some of remaining patterns.

For example, A h_{dist}^{max}={h_{dist}(l(\vec{e})|v,u)} is defined as the best (closest to 1) distance factor in a base B-tile. All of the titles do not need to be examined since proximity does not require much precision and the distance factor does not change much from one entity to another within most tiles. More generally, assume that l(\vec{e}) used in computation of a distance factor simply points to center of one sub-tile, and sub-tiles may be examined to find h_{dist}^{max}. If a pattern \vec{p} has a corresponding \vec{E}=(E₁ . . . Eₛ) such that

$${h}_{q} ( {E}^{->} ) < {h}_{q} ( {{e}_{0}}^{->} ) {h}_{loc} ( {{e}_{0}}^{->} ) \frac{{h}_{dist} ( {{e}_{0}}^{->} )}{{h}_{dist}^{max}}$$

\vec{p} can be skipped, since any entity set \vec{e}=(e₁ . . . eₛ)ε\vec{E} will be inferior to \vec{e₀}.

$$Proof \text{:} h ( {e}^{->} ) = {h}_{q} ( {e}^{->} ) {h}_{g} ( {e}^{->} ) \leq {h}_{q} ( {E}^{->} ) {h}_{dist} ( l ( {e}^{->} ) \text{\textbar} v , u ) {h}_{loc} ( {e}^{->} ) \leq {h}_{q} ( {E}^{->} ) {h}_{dist} ( l ( {e}^{->} ) \text{\textbar} v , u ) \leq \leq [ {h}_{q} ( {{e}_{0}}^{->} ) {h}_{loc} ( {{e}_{0}}^{->} ) \frac{{h}_{dist} ( {{e}_{0}}^{->} )}{{h}_{dist}^{max}} ] {h}_{dist} ( l ( {e}^{->} ) \text{\textbar} v , u ) = h ( {{e}_{0}}^{->} ) \frac{{h}_{dist} ( l ( {e}^{->} ) \text{\textbar} v , u )}{{h}_{dist}^{max}} \leq h ( {{e}_{0}}^{->} )$$

### Exemplary Operating Environment

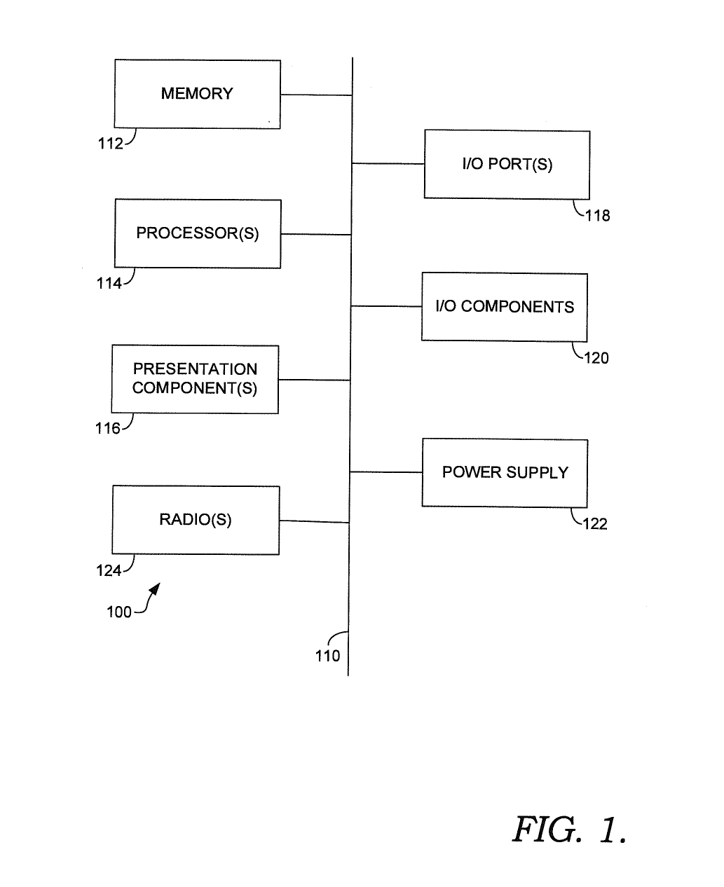

Referring to the drawings in general, and initially to FIG. 1 in particular, an exemplary operating environment for implementing aspects of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the invention may be practiced in a variety of system configurations, including handheld devices, consumer electronics, general-purpose computers, specialty computing devices, etc. Aspects of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more aspects of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in.

Illustrative I/O components include a microphone, joystick, game pad, satellite dish, scanner, printer, display device, wireless device, a controller (such as a stylus, a keyboard and a mouse), a natural user interface (NUI), and the like. In embodiments, a pen digitizer (not shown) and accompanying input instrument (also not shown but which may include, by way of example only, a pen or a stylus) are provided in order to digitally capture freehand user input. The connection between the pen digitizer and processor(s) 114 may be direct or via a coupling utilizing a serial port, parallel port, and/or other interface and/or system bus known in the art. Furthermore, the digitizer input component may be a component separated from an output component such as a display device or, in some embodiments, the usable input area of a digitizer may be co-extensive with the display area of a display device, integrated with the display device, or may exist as a separate device overlaying or otherwise appended to a display device. Any and all such variations, and any combination thereof, are contemplated to be within the scope of embodiments of the present invention.

A NUI processes air gestures, voice, or other physiological inputs generated by a user. Appropriate NUI inputs may be interpreted as ink strokes for presentation in association with the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

A computing device may include a radio. The radio transmits and receives radio communications. The computing device may be a wireless terminal adapted to received communications and media over various wireless networks. Computing device 1100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is second example of a short-range connection. A long-range connection may include a connection using one or more of CDMA, GPRS, GSM, TDMA, and 802.16 protocols.

### Exemplary Multi-Entity Query Service

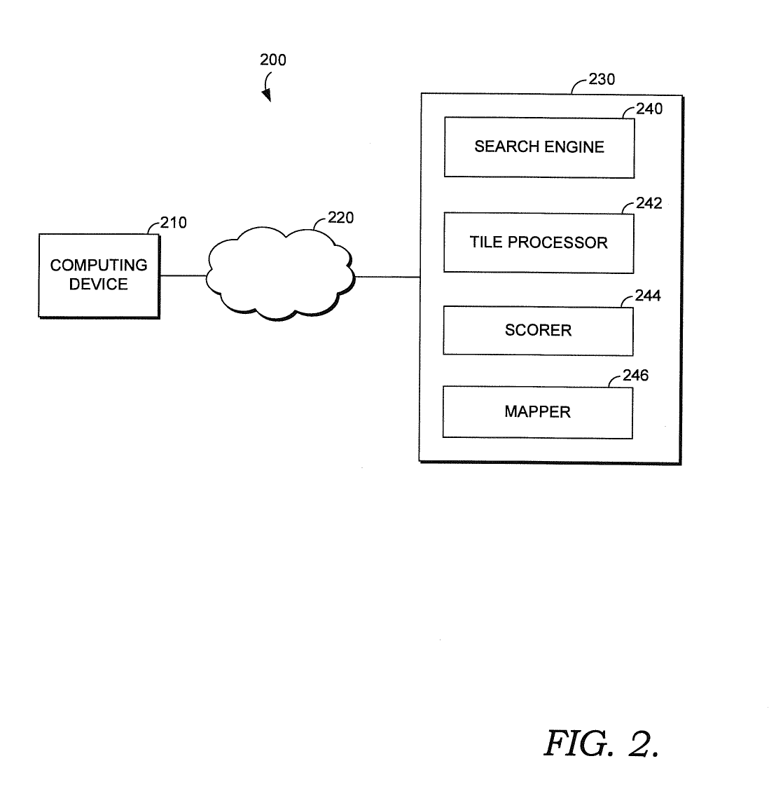

Turning now to FIG. 2, an exemplary computing environment 200 is depicted in accordance with one aspect of the present invention. The computing environment 200 includes a user's computing device 210 and a server 230, which are in communication with one another via a wide area network 220, such as the Internet. The computing device 210, can be similar to the computing device 100 described above with reference to FIG. 1. The computing device 210 can include a web browser and/or a mapping service application to submit a multi-entity query. The multi-entity query can be entered by the user or via another application. It should be understood and appreciated by those of ordinary skill in the art that the exemplary computing environment 200 is merely an example of one computing environment and is not intended to suggest any limitation as to the scope of use or functionality of the present invention. Neither should the exemplary computing environment 200 be interpreted as having any dependency or requirement related to any single module/component or combination of modules/components illustrated therein.

In aspects, computing device 210 can receive a query or search input from a user. The search input may comprise one or more alphanumeric characters forming part of a word, an entire word, or a series of words. The search input may be submitted to the computing device 210 in the form of keystrokes on a keyboard, handwritten input, or voice input. The handwritten input may be provided through a touchscreen interface or other suitable surface capable of digitizing handwriting into an input of computing device 210. The voice input may be received through a microphone associated with the computing device 210 and converted to text for use as a computing input. In each of the examples below, the search input is initially submitted through a user device. It should be noted, however, that embodiments are not limited to implementation on the computing device 210, but may be implemented on any of a variety of different types of computing devices within the scope of embodiments herein.

The server 230 may include, without limitation, a search engine 240, a tile processor 242, a scorer 244, and a mapper 246.

The search engine 240 can receive the search input from computing device 210 over the wide area network 220. In addition, the search engine 240 can, upon receipt of the search input, generate a series of search results related to the search input. The series of search results can be ranked in a manner typical to a search engine. For example, the series of search results may be ranked based on traffic to a website and/or links to that website found on other websites. The search engine 240 may use, e.g., an inverted index to rank the search results and return a result with the highest ranking.

In aspects, the tile processor 242 receives the search result and identifies a tile of a map view. In this example, a highest ranked search result can be used. However, this need not be the case for all embodiments. For example, more than one tile may be identified. The identified tiles may be ranked or unranked. Alternatively, tiles that match the search query above a certain threshold (e.g., the scored search results for a tile exceed a threshold) may be identified.

The scorer 244 can determine valid query patterns for the identified tile from the search query and score the valid query patterns to obtain a potential score for each of the determined valid query patterns. Then, using a geo-spatial collocation factor of the entities in the query pattern, an actual score can be determined for the determined valid query patterns from the potential score. The geo-spatial collocation factor can be correlated with the Cartesian distance between the entities. For example, for a business name, the location of the business can be determined by, e.g., the latitude and longitude of the business. If the entities in a valid search query are at the same location, i.e., same latitude and longitude coordinates, the potential score may equal the actual score.

The mapper 246 can take the results of the scorer 244 and use the results to modify a map view. For example, if the highest scored valid query pattern corresponds to an intersection, a map view may be provided with highlights overlaying the intersecting streets. As another example, if the highest scored valid query pattern corresponds to non-intersecting streets, highlights can be displayed on the map view overlaying the non-intersecting streets. Although, mapper 246 is described as modifying a map view, this need not always be the case. For example, the mapper 246 can output instructions to the computing device 210 to draw the entities on a web page or mapping application. The mapper 246 may output data that is used in another application to display the results or otherwise use the results.

While the server 230 is illustrated as a single unit, one skilled in the art will appreciate that the server 230 is scalable. For example, the server 230 may in actuality include a plurality of servers in communication with one another. Moreover, the tile processor 242 may be part of the search engine 240. The single unit depictions are meant for clarity, not to limit the scope of embodiments in any form.

### Exemplary Method for a Multi-Entity Query

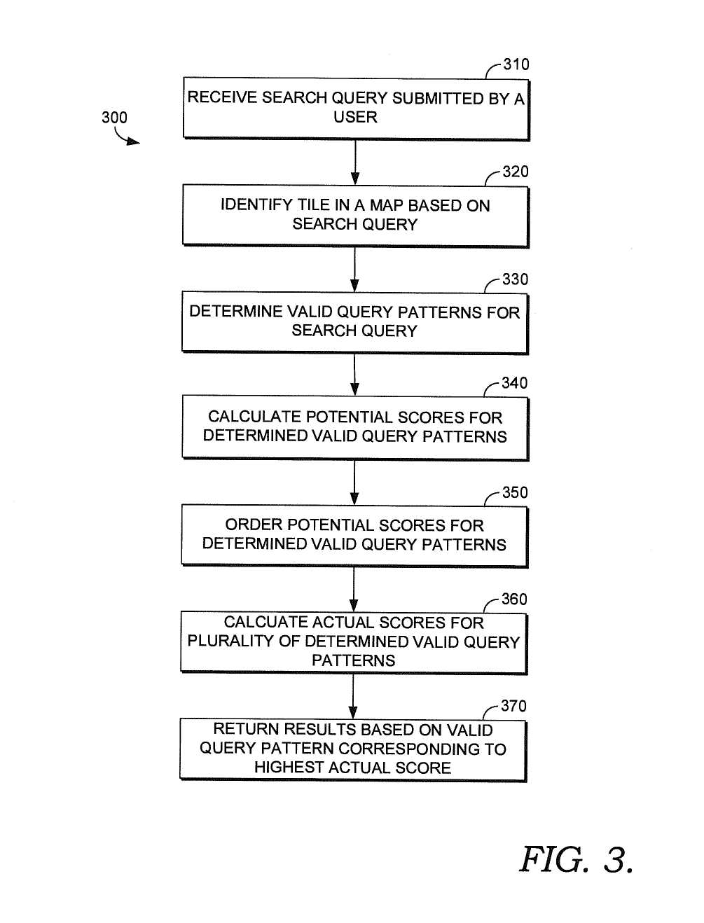

Turning now to FIG. 3, a method 300 for resolving multi-entity geocoding queries is shown, in accordance with an aspect of the present invention. Method 300 may be performed on a one or more servers in a data center or across multiple data centers. Alternatively, method 300 may be performed by a user's computing device, such as a tablet, smartphone, or personal computer.

At step 310, a search query submitted by a user may be received. The search query may comprise one or more alphanumeric characters forming part of a word, an entire word, or a series of words. The search query may be submitted in the form of keystrokes on a keyboard, handwritten input, or voice input. The handwritten input may be provided through a touchscreen interface or other suitable surface capable of digitizing handwriting into a computer input. The voice input may be received through a microphone associated with a computing device and converted to text for use as a computing input. In each of the examples above, the search query is initially submitted through a user device.

Though the search query may be initially submitted through a keyboard, microphone, or touch surface, aspects of the present invention may also use “received” in a sense of receiving the search query from another computing component. The computing component may be local or remote. For example, a cloud-based search engine may receive the search query from a computing device over a network connection. Alternatively, a search customization component running on a smartphone may receive the query from a query component also running on the smartphone.

At step 320, a tile in a map is identified based on the search query. Using conventional search capabilities, one or more results may be obtained based on the search query. The one or more search results may be associated with one or more tiles in a map. For example, a conventional search may rank tiles based on the search terms and return the results in a ranked order. The rankings may be done using search heuristics, including, but not limited to, the use of an inverted index.

In some examples, a search query may resolve to more than one tile, and a single tile among the more than one tile may be chosen. This allows the search area to be constrained to a single tile, speeding the search result time and reducing computing processing power. For example, one or more tile may be returned based on the search query. As in a conventional search, the search results are returned in a ranked hierarchy based on the search query. In this case, the tile with the highest rank may be selected.

At step 330, valid query patterns for the search query corresponding to entities on the identified tile are determined. The search query may be divided into segments, and each segments may be analyzed to determine if it resolve to at least one entity on the identified tile. If the segments correspond to entities on the identified tile, then it is determined whether the entities corresponding to the segments reside on the same sub-tile. A valid query pattern is one where the segments of the search query resolve to entities on the identified tile and the entities are found on the same sub-tile. The search query may be divided into segments that resolve to two or more entities. For example, using an inverted index, all objects found on the tile can be identified and it can be determined whether the two or more entities are found on the identified tile. Furthermore, it can be determined whether the two or more entities are found on a common sub-tile of the identified tile.

Although is it described above that the entities for a valid query pattern reside on the same sub-tile, it need not necessarily be the case. For example, if any combination of entities on a tile is desired, then it need only be determined whether the segments of the search query resolve to entities on the tile.

At step 340, potential scores for each of the determined valid query patterns can be calculated. For example, a static rank, textual factor, and location factor for each entity of a valid query pattern can be obtained and the potential score for each determined valid query pattern can be calculated based on the static rank, textual factor, and location factor for each entity.

At step 350, potential scores for the determined valid query patterns may be ordered. Although, in some embodiments, the potential scores need not be ordered, ordering potential scores may reduce the number of query patterns to be examined, thereby further improving speed and the consumption of computing resources.

At step 360, actual scores for a plurality of the determined valid query patterns may be calculated. For example, the actual score for a valid query pattern may be the potential score of the valid query pattern reduced by a geo-spatial collocation factor. For example, the geo-spatial collocation factor can correlate to the Cartesian distance between the entities of the determined valid query pattern. In this example, the actual score is calculated by the potential score of a valid query pattern reduced by a geo-spatial collocation factor. However, the actual score need not use a geo-spatial collocation factor and the actual score may be calculated by alternative means. For example, an actual distance value may be calculated to arrive at an actual score, and the distance value may be normalized to correlate to the potential score. For example, if a range of potential scores is 0 to 1, where 1 corresponds to a query pattern where the entities are likely to be found at the same location, the distance value can be normalized so that an actual score of 1 would mean that the entities are found in the same location and an actual score of 0 would mean that the entities are far from each other (indicating there is no relationship between the entities). This allows for remaining query patterns to not have their actual scores calculated if the actual distance value for a query pattern is within a desired range or threshold.

In some embodiments, only those valid query patterns whose potential score is greater than the highest calculated actual score need to have their actual score calculated. For those valid query patterns whose potential score is less than the highest actual score, an actual score need not be calculated since their actual score may not exceed their potential score. By only calculating scores for query patterns with potential scores greater than the highest actual score, fewer operations are required, decreasing the time need to perform the query.

At step 370, results based on the valid query pattern with the highest actual score may be returned. The results may be returned such that entities corresponding to the valid query pattern with the highest actual score are identified and are highlighted on a map view. For example, the results may be returned as an image, an overlay on a map view, or another format indicating the entities on the grid. In other embodiments, the results may be returned as a different format in order for, e.g., a user computing device to create the displayed entities. As only the results with the highest actual score are returned, the likelihood of the search results being accurate improve, thereby requiring fewer queries to be performed. This configuration increases user efficiency and reduces network bandwidth usage.

### Another Exemplary Method for a Multi-Entity Query

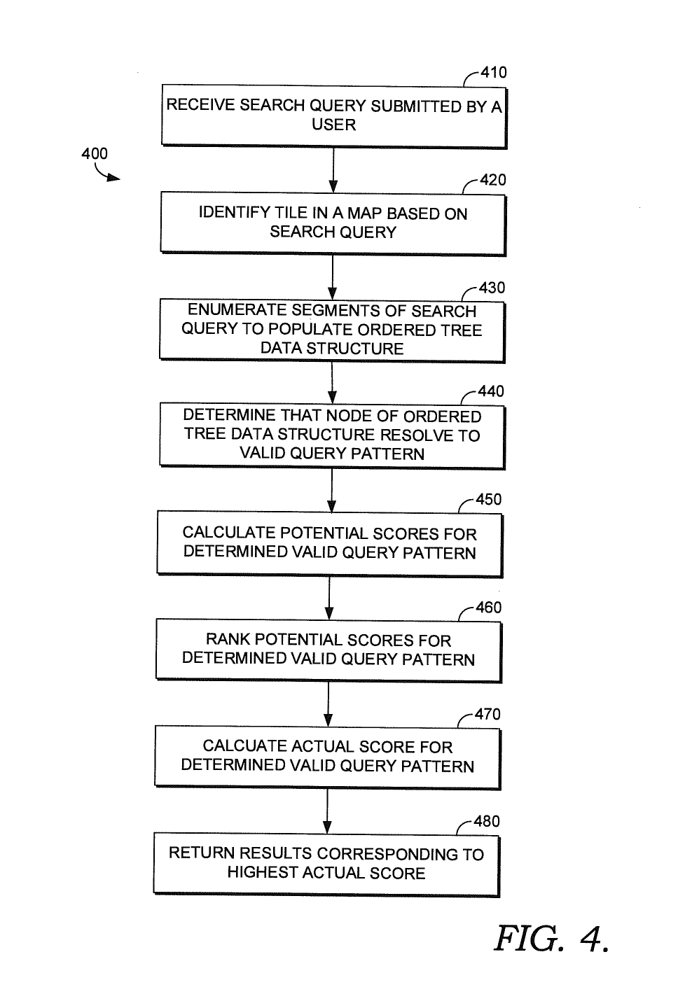

Turning now to FIG. 4, a method 400 for resolving multi-entity geocoding queries is shown, in accordance with another aspect of the present invention. Method 400 may be performed on a one or more servers in a data center or across multiple data centers. Alternatively, method 400 may be performed by a user's computing device, such as a tablet, smartphone, or personal computer.

At step 410, a search query may be submitted by a user. The search query may comprise one or more alphanumeric characters forming part of a word, an entire word, or a series of words. The search query may be submitted in the form of keystrokes on a keyboard, handwritten input, or voice input. The handwritten input may be provided through a touchscreen interface or other suitable surface capable of digitizing handwriting into a computer input. The voice input may be received through a microphone associated with a computing device and converted to text for use as a computing input. In each of the examples above, the search query is initially submitted through a user device.

At step 420, a tile in a map may be identified based on the search query. Using conventional search capabilities, one or more results may be obtained based on the search query. The one or more search results may be associated with a tile in a map. For example, a conventional search may rank tiles based on the search terms and return the results in a ranked order. The rankings may be done using search heuristics, including, but not limited to, use of an inverted index.

At step 430, the segments of the search query may be enumerated to populate an ordered tree data structure. For example, for the search query “Baker St and Main St,” the segments of the search query may include “Baker” or “Baker St.” Based on the segments, an ordered data tree structure may be populated, where the top level node contains a single segment. For example, for a search query with 4 terms [1, 2, 3, 4], the top-level node may contain the segment [1, 2, 3, 4]. Each node of the ordered tree data structure may comprise one or more segments that form the search query. In other words, a node may comprise a combination of segments that represents the search query.

At step 440, it may be determined that at least one node of the ordered data tree structure resolves to a valid query pattern. For a valid query pattern, each segment of the node matches at least one entity on the tile, and the matched entities reside in a common sub-tile of the tile. For example, using the search query “Baker St and Main St,” “Baker St,” “Main St” may resolve to a valid query pattern. If Baker St and Main St are entities found in the tile and they reside in the same sub-tile, the query pattern may be considered valid. If no node resolves to a valid query pattern, a new tile may be identified and the steps may be repeated. Alternatively, a single-entity query may be performed and the results returned. The presence of an entity on the tile can be determined by matching a segment of a node with an entity in an inverted index corresponding to the identified tile. If a node of the ordered tree data structure is found to be an invalid query pattern, the children nodes of the node may be pruned (as is described herein).

At step 450, the potential score for the determined valid query pattern may be calculated. A static rank, textual factor, and location factor for each entity of the determined valid query pattern may be determined. Then, the static rank, textual factor, and location factor for each entity may be combined to obtain a potential score for the determined valid query pattern.

At step 460, the potential score for the determined valid query patterns may be ranked against any other valid query pattern that was determined. At step 470, an actual score for the determined valid query pattern may be calculated. The calculation of the actual score may be calculated by reducing the potential score by a factor determined by a geo-spatial collocation of entities of the determined valid query pattern. To further reduce the time and computing resources expended, the nodes on the same level of the ordered tree data structure may be ranked, and an actual score may be calculated for a limited number of nodes on that level. For example, given an ordered data tree structure, the actual scores for the top three nodes for each level may be calculated, reducing the number of calculations needed to be performed, thereby allowing the query to be performed faster.

At step 480, pattern results corresponding to the highest actual score among the actual scores for the determined valid query pattern and other valid query patterns may be returned.

For some nodes, an entity may difficult to resolve. For example, “St” may resolve to numerous entities and may not provide much value when analyzing the entities on the tile. For example, the entity “St” will likely be found on a tile and will likely be closely collocated to any other entities in the search query. In this case, the entity “St” may be excluded so that the steps performed do not use “St.”

### Another Exemplary Method for a Multi-Entity Query

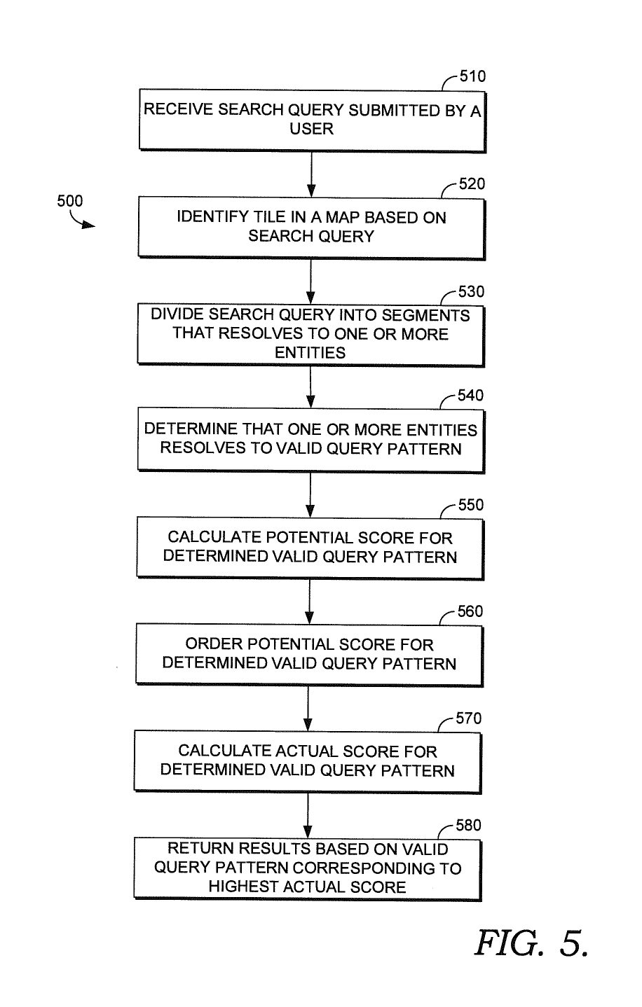

Turning now to FIG. 5, a method 500 for resolving multi-entity queries on a map is shown, in accordance with yet another aspect of the present invention. Method 500 may be performed on a one or more servers in a data center or across multiple data centers. Alternatively, method 500 may be performed by a user's computing device, such as a tablet, smartphone, or personal computer.

At step 510, a search query submitted by a user may be received. The search query may comprise one or more alphanumeric characters forming part of a word, an entire word, or a series of words. The search query may be submitted in the form of keystrokes on a keyboard, handwritten input, or voice input. The handwritten input may be provided through a touchscreen interface or other suitable surface capable of digitizing handwriting into a computer input. The voice input may be received through a microphone associated with a computing device and converted to text for use as a computing input. In each of the examples above, the search query is initially submitted through a user device.

At step 520, a tile in a map may be identified based on the search query. Using conventional search capabilities, one or more results may be obtained based on the search query. The one or more search results may be associated with a tile in a map. For example, a conventional search may rank tiles based on the search terms and return the results in a ranked order. The rankings may be done using search heuristics, including, but not limited to, use of an inverted index.

At step 530, the search query may be divided into segments that correspond to one or more entities. Each entity may be associated with the identified tile via an inverted index.

At step 540, a valid query pattern for the search query in the identified tile may be determined. As described herein, the search query may be divided into segments, and the segments may be analyzed to determine if they resolve to entities on the identified tile. If the segments resolve to entities on the identified tile, then it is determined whether the entities corresponding to the segments reside on the same sub-tile.

Although is it described herein that the entities for a valid query pattern reside on the same sub-tile, it need not necessarily be the case. For example, if any combination of entities on a tile is desired, then it only needs to be determined whether the segments of the search query resolve to entities on the tile.

At step 550, a potential score for the determined valid query patterns may be calculated using a static rank, textual factor, and location factor of each of the one or more entities of the determined valid query pattern, and at step 560, potential scores for the determined valid query pattern and other valid query patterns may be ordered. At step 570, an actual score for a determined valid query pattern whose potential score exceeds a highest actual score may be calculated. At step 580, results based on a valid query pattern corresponding to the highest actual score may be returned.

### Multi-Entity Search Examples

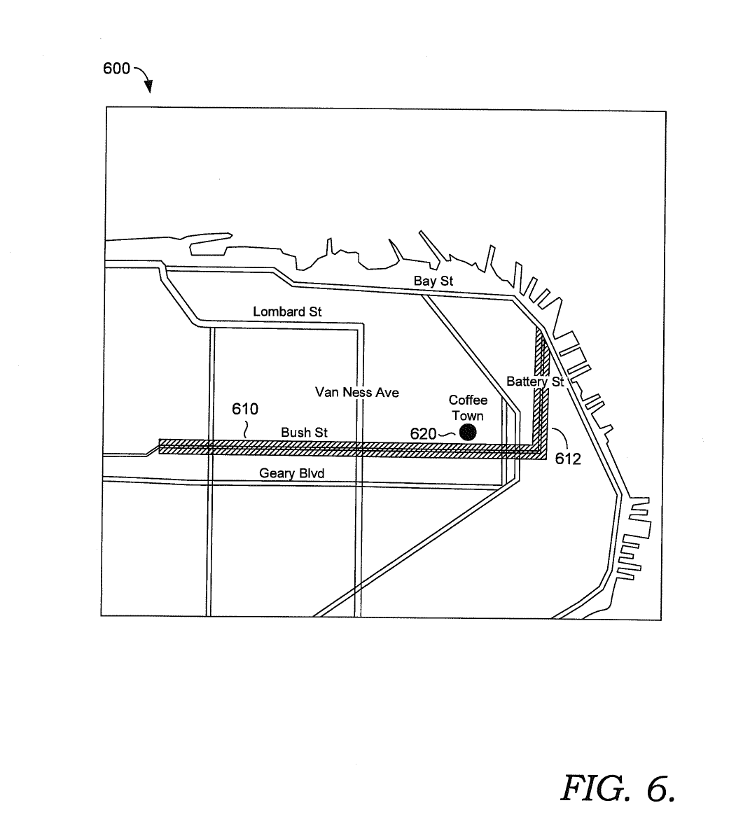

Turning now to FIG. 6, a map 600 depicting the results of a multi-entity query search comprising intersecting streets and a business name is provided, in accordance with an aspect of the present invention. For example, a user can input a query “Coffee Town near Battery St and Bush St.” A conventional geocoding search engine may not know how to interpret this query. The query may be analyzed as a single-entity query. However, the entity “Coffee Town near Battery St and Bush St” may not be found. Alternatively, formal grammar, such as “business near location” may be used. However, “Battery St and Bush St” may not be found or may not provide the known intersection. Other search techniques may be used, but they each have their own drawbacks.

In accordance with an aspect of this invention, a tile may be determined Using the search query “Coffee Town near Battery St and Bush St,” a single tile may be identified and the search terms “Coffee Town” “Battery St” “Bush St” may be determined “Coffee Town,” “Battery St,” “Bush St” may be found on the given tile, and thus “[Coffee Town][Battery St][Bush St] may be a valid query pattern. Potential scores for all valid query patterns may be calculated and ordered. Since there may be more than one Coffee Town, only the Coffee Town near the intersection is desired. Thus, based on the geo-spatial collocation of the entities (e.g., the potential score reduced by the geo-spatial collocation factor), the entities that are close in distance are returned. As shown on the map 600, the intersection of Bush St 610 and Battery St 612 are highlighted. The Coffee Town 620 closest to that intersection is also indicated in the map.

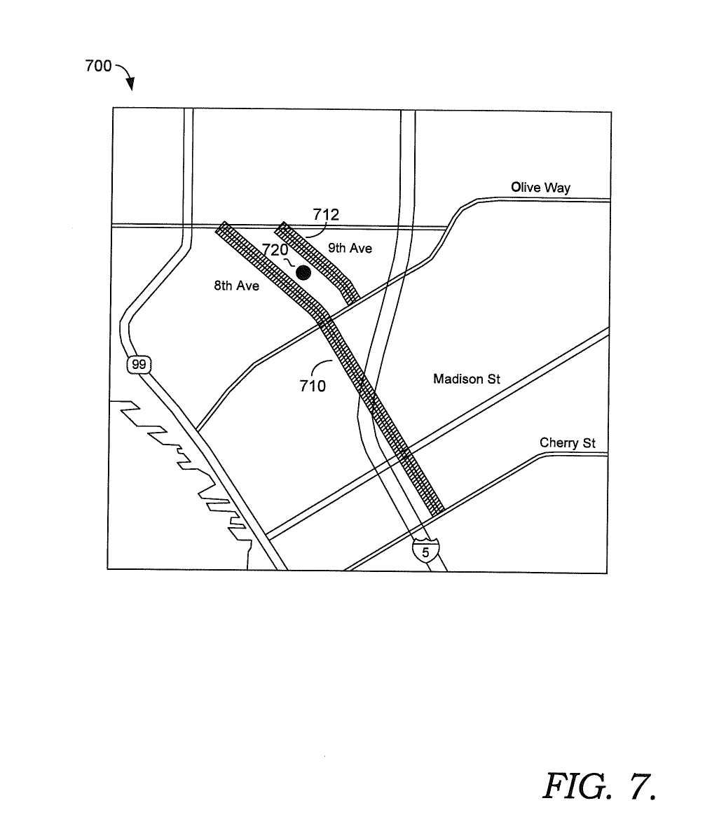

Turning now to FIG. 7, a map 700 depicting the results of a multi-entity query search comprising non-intersecting streets is provided, in accordance with an aspect of the present invention. Given a search query such as “8^{th} Ave and 9^{th} Ave,” a map 700 can be provided with the street 8^{th} Ave 710 and 9^{th} Ave 712 highlighted. As an orientation point, an indicator 720 between the two streets may be provided.

### Embodiment 1

A first embodiment of the invention is directed to one or more computer-storage media that cause a computing device to perform a method of resolving multi-entity geocoding queries. The method comprises identifying a tile in a map based on the search query; determining valid query patterns for the search query in the identified tile; calculating a potential score for each of the determined valid query patterns; ordering the potential scores for the determined valid query patterns; calculating actual scores for a plurality of the determined valid query patterns, the potential score of each of the plurality of the determined valid query patterns being greater than a highest actual score; and returning results based on a valid query pattern corresponding to the highest actual score.

### Embodiment 2

A media according to Embodiment 1, wherein the determining valid query patterns comprises: dividing the search query into segments that resolve to two or more entities, wherein the two or more entities are found on the identified tile; and determining that the two or more entities are found on a common sub-tile of the identified tile.

### Embodiment 3

A media according to Embodiment 1 or 2, wherein the calculating a potential score comprises: obtaining a static rank, textual factor, and location factor for each entity of each determined valid query pattern; calculating a potential score for each determined valid query pattern based on the static rank, textual factor, and location factor for each entity of the determined valid query pattern.

### Embodiment 4

A media according to any of Embodiments 1-3, wherein the calculating actual scores comprises: determining that a potential score for a plurality of the determined valid query patterns is greater than the highest actual score; and calculating the actual scores for the plurality of the determined valid query patterns based on a collocation of two or more entities of the determined valid query pattern.

### Embodiment 5

A media according to any of Embodiments 1-4, wherein the returning results comprises: identifying two or more entities on the tile matching the valid query pattern corresponding to the highest actual score; and highlighting the two or more entities on the map.

### Embodiment 6

A media according to any of Embodiments 1-5, wherein the search query comprises at least two non-intersecting streets, or at least two intersecting streets and a business name.

### Embodiment 7

Another embodiment of the invention is directed to a computer-implemented method of resolving multi-entity geocoding queries. The method comprises receiving, at a computing device, a search query; identifying a tile in a map based on the search query; enumerating segments of the search query to populate an ordered tree data structure, a node of the ordered tree data structure comprising one or more segments that form the search query; determining that a node of the ordered tree data structure resolves to a valid query pattern; calculating a potential score for the determined valid query pattern; ranking the potential score for the determined valid query pattern against potential scores of other valid query patterns; calculating an actual score for the determined valid query pattern; and returning results corresponding to a highest actual score among the determined valid query pattern and other valid query patterns.

### Embodiment 8

A method according to Embodiment 7, wherein each segment of the search query comprises one or more contiguous terms of the search query, and a node comprises a combination of segments that represents the search query.

### Embodiment 9

A method according to Embodiment 7 or 8, wherein the determining that a node of the tree data structure resolves to a valid query pattern comprises: determining that each segment of the node matches at least one entity on the tile; and determining that the matched entities reside in a common sub-tile of the tile.

### Embodiment 10

A method according to Embodiment 9, wherein a presence of an entity on the tile is determined by matching a segment of a node with an entity in an inverted index corresponding to the identified tile.

### Embodiment 11

A method according to any of Embodiments 7-10, wherein the calculating a potential score comprises: determining a static rank, textual factor, and location factor for each entity of the determined valid query pattern; and combining the static rank, textual factor, and location factor for each of the entities to obtain a potential score for the determined valid query pattern.

### Embodiment 12

A method according to any of Embodiments 7-11, wherein the calculating an actual score comprises: reducing the potential score by a factor determined by a collocation of entities of the determined valid query pattern.

### Embodiment 13

A method according to any of Embodiments 7-12, further comprising pruning children nodes of a node of the ordered tree data structure that resolves to an invalid query pattern.

### Embodiment 14

A method according to any of Embodiments 7-13, wherein the nodes on a level of the ordered tree data structure are ranked against other nodes on a same level, and an actual score is calculated for a limited number of nodes of the level.

### Embodiment 15

A method according to any of Embodiments 7-14, further comprising eliminating at least one entity in a query pattern wherein the at least one entity is an excluded term.

### Embodiment 16

Another embodiment of the invention is directed to one or more computer-storage media that cause a computing device to perform a method of multi-entity searching on a map. The method comprises: receiving a search query; identifying a tile in a map based on the search query; dividing the user query into segments that resolve to one or more entities, each entity being associated with the identified tile via an inverted index; and determining that the one or more entities resolves to a valid query pattern, the one or more entities of the valid query pattern residing in a common sub-tile of the tile; calculating a potential score for the determined valid query pattern using a static rank, textual factor, and location factor of each of the one or more entities of the determined valid query pattern; ordering the potential score for the determined valid query pattern with potential scores of other valid query patterns; calculating an actual score for the determined valid query pattern whose potential score exceeds a highest actual score; and returning results based on a valid query pattern corresponding to the highest actual score.

### Embodiment 17

A media according to Embodiment 16, wherein the static rank is based on a population of a city.

### Embodiment 18

A media according to Embodiment 16 or 17, wherein the textual factor is an indication of how closely the segment matches the corresponding entity.

### Embodiment 19

A media according to any of Embodiments 16-18, wherein the location factor is based on the user location.

Accordingly, embodiments of the invention may be described in the general context of computer-executable instructions, such as program modules, being executed by a computer. Generally, program modules include routines, programs, objects, components, data structures, etc., that perform particular tasks or implement particular abstract data types. The embodiments may also be practiced in distributed computing environments or cloud environments where tasks are performed by remote-processing devices that are linked through a communications network. In a distributed computing environment, program modules may be located in both local and remote computer storage media including memory storage devices.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

Aspects of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media storing computer-executable instructions that, when executed by a computing device having a processor, cause the computing device to perform a method of resolving multi-entity geocoding queries, the method comprising:
receiving a search query;
identifying a tile in a map based on the search query;
determining valid query patterns for the search query in the identified tile;
calculating a potential score for each of the determined valid query patterns;
ordering the potential scores for the determined valid query patterns;
calculating actual scores for a plurality of the determined valid query patterns, the potential score of each of the plurality of the determined valid query patterns being greater than a highest actual score; and
returning results based on a valid query pattern corresponding to the highest actual score.

2. The media of claim 1, wherein the determining valid query patterns comprises:
dividing the search query into segments that resolve to two or more entities, wherein the two or more entities are found on the identified tile; and
determining that the two or more entities are found on a common sub-tile of the identified tile.

3. The media of claim 1, wherein the calculating a potential score comprises:
obtaining a static rank, textual factor, and location factor for each entity of each determined valid query pattern; and
calculating a potential score for each determined valid query pattern based on the static rank, textual factor, and location factor for each entity of the determined valid query pattern.

4. The media of claim 1, wherein the calculating actual scores comprises:
determining that a potential score for a plurality of the determined valid query patterns is greater than the highest actual score; and
calculating the actual scores for the plurality of the determined valid query patterns based on a collocation of two or more entities of the determined valid query pattern.

5. The media of claim 1, wherein the returning results comprises:
identifying two or more entities on the tile matching the valid query pattern corresponding to the highest actual score; and
highlighting the two or more entities on the map.

6. The media of claim 1, wherein the search query comprises at least two non-intersecting streets.

7. The media of claim 1, wherein the search query comprises at least two intersecting streets and a business name.

8. A method of resolving multi-entity geocoding queries, the method comprising:
receiving, at a computing device, a search query;
identifying a tile in a map based on the search query;
enumerating segments of the search query to populate an ordered tree data structure, a node of the ordered tree data structure comprising one or more segments that form the search query;
determining that a node of the ordered tree data structure resolves to a valid query pattern;
calculating a potential score for the determined valid query pattern;
ranking the potential score for the determined valid query pattern against potential scores of other valid query patterns;
calculating an actual score for the determined valid query pattern; and
returning results corresponding to a highest actual score among the determined valid query pattern and other valid query patterns.

9. The method of claim 8, wherein each segment of the search query comprises one or more contiguous terms of the search query, and a node comprises a combination of segments that represents the search query.

10. The method of claim 8, wherein the determining that a node of the tree data structure resolves to a valid query pattern comprises:
determining that each segment of the node matches at least one entity on the tile; and
determining that the matched entities reside in a common sub-tile of the tile.

11. The method of claim 10, wherein a presence of an entity on the tile is determined by matching a segment of a node with an entity in an inverted index corresponding to the identified tile.

12. The method of claim 8, wherein the calculating a potential score comprises:
determining a static rank, textual factor, and location factor for each entity of the determined valid query pattern; and
combining the static rank, textual factor, and location factor for each of the entities to obtain a potential score for the determined valid query pattern.

13. The method of claim 8, wherein the calculating an actual score comprises:
reducing the potential score by a factor determined by a geo-spatial collocation of entities of the determined valid query pattern.

14. The method of claim 8, further comprising pruning children nodes of a node of the ordered tree data structure that resolves to an invalid query pattern.

15. The method of claim 8, wherein the nodes on a level of the ordered tree data structure are ranked against other nodes on a same level, and an actual score is calculated for a limited number of nodes of the level.

16. The method of claim 8, further comprising eliminating at least one entity in a query pattern wherein the at least one entity is an excluded term.

17. A system for performing multi-entity searching on a map, comprising:
a search engine configured to receive a search query;
a tile processor configured to:
identify a tile in a map based on the search query; and
divide the user query into segments that resolve to one or more entities, each entity being associated with the identified tile via an inverted index;
a scorer configured to:
determine that the one or more entities resolves to a valid query pattern, the one or more entities of the valid query pattern residing in a common sub-tile of the tile,
calculate a potential score for the determined valid query pattern using a static rank, textual factor, and location factor of each of the one or more entities of the determined valid query pattern;
order the potential score for the determined valid query pattern against potential scores of other valid query patterns; and
calculate an actual score for the determined valid query pattern whose potential score exceeds a highest actual score; and
a mapper configured to return results based on a valid query pattern corresponding to the highest actual score.

18. The system of claim 17, wherein the static rank is based on a population of a city.

19. The system of claim 17, wherein the textual factor is an indication of how closely the segment matches the corresponding entity.

20. The system of claim 17, wherein location factor is based on the user location.
